(19) United States
(12) Patent Application Publication
(10) Pub. No.: US 2018/0117629 A1
(43) Pub. Date: May 3, 2018

(54) Coating Method

(71) Applicant: Akzo Nobel Coatings International B.V., Arnhem (NL)

(72) Inventors: Frank Jöge, Sendenhorst (DE); Jörg Ressel, Paderborn (DE)

(21) Appl. No.: 15/565,561

(22) PCT Filed: Mar. 30, 2016
(86) PCT No.: PCT/EP2016/056868

§ 371 Date: Oct. 10, 2017

(30) Foreign Application Priority Data
Apr. 17, 2015 (EP) 15163989.5

(51) Int. Cl. B05D 7/00; B05D 3/10; C09D 7/20; C09D 7/61; C09D 167/02; C09D 175/04

(52) U.S. Cl. CPC B05D 7/572; B05D 7/532; B05D 3/102; B05D 3/108; C09D 7/20; C08K 5/0025; C09D 167/02; C09D 175/04; B05D 2202/00; B05D 2503/00; B05D 2508/00; C09D 7/61

(57) ABSTRACT

The present invention relates to a process for applying a topcoat to at least one side of a substrate, comprising a step (a) of at least partly coating at least one substrate metal surface, at least partly coated with at least one primer coat, with an aqueous coating composition which comprises at least one polymer dissolved or dispersed therein, the coating composition further comprising at least one mixed hydroxide of the general formula (I), and the process being a coil coating process; to a topcoat applied to at least one side of the substrate and obtainable by this process; to a substrate at least partly coated on at least one side with a topcoat by this process; and also to a use of this coating composition for at least partly coating at least one substrate metal surface, at least partly coated with at least one primer coat, with a topcoat in a coil coating process.

The present invention relates to a process for applying a topcoat to at least one side of a substrate, comprising a step (a) of at least partly coating at least one substrate metal surface, at least partly coated with at least one primer coat, with an aqueous coating composition which comprises at least one polymer dissolved or dispersed therein, the coating composition further comprising at least one mixed hydroxide of the general formula (I), and the process being a coil coating process; to a topcoat applied to at least one side of the substrate and obtainable by this process; to a substrate at least partly coated on at least one side with a topcoat by this process; and also to the use of this coating composition for at least partly coating at least one substrate metal surface, at least partly coated with at least one primer coat, with a topcoat in a coil coating process.

For the production of flat and thin-walled metallic components such as, for example, automobile components and bodywork components, but also corresponding components from the sector of equipment casings, façade sheeting, ceiling claddings, or window profiles, suitable metal sheets such as steel or aluminum sheets, for example, are shaped by means of conventional technologies such as punching and/or drilling. Larger metallic components may be assembled by welding together a number of individual parts. Commonly in use as raw material for producing such components are long metal strips, which are produced by rolling of the metal in question and which, for the purpose of storage and for greater ease of transport, are wound up to form rolls (“coils”).

The stated metallic components must commonly be protected against corrosion. In the automobile sector in particular, the corrosion prevention requirements are very high, especially since the manufacturers often offer a guarantee against rust penetration for many years. This anticorrosion treatment may be carried out on the completed metallic component, such as an automobile body welded together, for example. Increasingly, however, the anticorrosion treatment is nowadays undertaken at an earlier point in time, namely on the actual metal strips used for producing these components, by means of the coil coating process.

In addition, however, it is also necessary that the paint coatings on the metal strips coated by means of the coil coating process also have sufficient UV resistance, especially with respect to UV-A radiation.

Coil coating is the continuous, single- or double-sided coating of flat rolled metal strips, such as of steel or aluminum strips, for example, with usually liquid coating compositions at speeds of approximately 60 to 200 m/min. This coil coating normally takes place in roll application with counterrotating rolls. After the coil coating process has been carried out, the metal strips generally have a number of different paint coats, of which at least one is responsible for sufficient corrosion protection. Normally, after an optional cleaning step for the metal strip and after application of a thin pretreatment coat, a coat of primer is applied to the pretreatment coat, followed by the application of at least one topcoat to the primer coat (2-step application). A coil coating process known from the prior art is disclosed in WO 2006/079628 A2, for example. Given that the (further) metal processing of the metal strips thus coated does not usually take place until after painting by means of the coil coating process, the coating materials employed for this purpose, especially topcoat materials, are required to exhibit very high mechanical stability and also, according to intended use, very high weather resistance and/or chemical resistance, particularly in view of the fact that they are often used in the outdoor sector. This also includes the aforementioned sufficient UV resistance, especially with respect to UV-A radiation.

A disadvantage of the liquid coating compositions typically used in the coil coating process particularly for the application of at least one topcoat is often the presence therein of organic solvents, more particularly the presence therein of relatively nonvolatile organic solvents, this being objectionable on environmental grounds. Typically the presence of organic solvents, however, is necessary, especially in the coating compositions used for producing topcoats by means of the coil coating process, since aqueous conventional coating compositions do not ensure sufficient UV resistance, especially sustained UV resistance, and especially with respect to UV-A radiation, on the part of the topcoats resulting from the process.

WO 2009/062621 A1 discloses coating materials for producing surfacer coats that comprise a first polymer, containing functional groups, and a second polymer, and/or crosslinking agent(s). These coating materials further comprise anisotropic particles such as mixed hydroxides. Further coats are applied to the surfacer coats produced in this way. WO 2010/130308 A1 relates to a waterborne effect basecoat material which comprises a liquid-crystalline aqueous preparation, which in turn has positively charged, layerlike inorganic particles whose charge is at least partly compensated by singly charged organic anions. Further coats are applied to the basecoats. WO 2013/056846 A1 relates to a process for producing an anticorrosion coating which comprises, among other ingredients, a layered double hydroxide containing organic anions. Further coats are applied to this anticorrosion coating.

A need exists for coating compositions which can be employed in a coil coating process for producing topcoats and which not only are less environmentally objectionable than the compositions commonly employed, meaning that they are substantially free from organic solvents, especially relatively nonvolatile organic solvents, but also have no disadvantages in terms of their resistance to UV radiation, especially with respect to UV-A radiation.

It is an object of the present invention, therefore, to provide a coating composition which is suitable for producing a topcoat in a coil coating process and which has no disadvantages, and in particular has advantages, over conventional coating compositions used in the coil coating process for producing a topcoat. It is an object of the present invention more particularly to provide a coating composition of this kind which can be used in a coil coating process and which is less environmentally objectionable, being more particularly substantially free from organic solvents, than the compositions typically employed, but is nevertheless at least equally suitable, and in particular to an advantageous degree, for ensuring sufficient, and in particular sustained, resistance to UV radiation, more particularly with respect to UV-A radiation.

This object is achieved by the subject of the present claims and of the preferred embodiments of said subjects that are disclosed in the description.

A first subject of the present invention that achieves this object is a process for applying a topcoat to at least one side of a substrate, comprising at least one step (a) of

(a) at least partly coating at least one substrate metal surface, at least partly coated with at least one primer coat, with an aqueous coating composition,
the aqueous coating composition comprising
   (A) at least one polymer dissolved or dispersed therein and
   (B) optionally at least one crosslinking agent dissolved or dispersed therein,
wherein the aqueous coating composition further comprises at least one mixed hydroxide of the general formula (I) below

{[(M²⁺₍₁₋ₓ₎)(M³⁺₍ₓ₎)(OH)₂][A^{y-}_{(x/y)}]}·(H₂O)ₙ (I),
in which
M²⁺ stands for divalent metallic cations,
M³⁺ stands for trivalent metallic cations,
A^{y-} stands for anions of average valence y,
x stands for a value in the range from 0.05 to 0.50, and
n stands for a value in the range from 0 to 10, and
   wherein the process is a coil coating process.

A second subject of the present invention that achieves this object is a use of the aqueous coating composition used in the process above, i.e., the use of a coating composition which comprises
(A) at least one polymer dissolved or dispersed therein and
(B) optionally at least one crosslinking agent dissolved or dispersed therein
   and further comprises at least one mixed hydroxide of the general formula (I) below

{[(M²⁺₍₁₋ₓ₎)(M³⁺₍ₓ₎)(OH)₂][A^{y-}_{(x/y)}]}·(H₂O)ₙ (I),
wherein
   M²⁺ stands for divalent metallic cations,
   M³⁺ stands for trivalent metallic cations,
   A^{y-} stands for anions of average valence y,
   x stands for a value in the range from 0.05 to 0.50, and
   n stands for a value in the range from 0 to 10,
      for at least partly coating at least one substrate metal surface, coated at least partly with at least one primer coat, with a topcoat in a coil coating process.

It has surprisingly been found that the aqueous coating composition used in accordance with the invention in step (a) is suitable in a coil coating process for applying a topcoat to at least one side of a substrate. Moreover, the coating composition used in accordance with the invention is notable for being aqueous and therefore less environmentally objectionable than conventional coating compositions comprising organic solvents.

It has been surprisingly found in particular that by virtue of the specific constituents of the coating composition used in accordance with the invention, especially the presence of the at least one mixed hydroxide of the general formula (I) in the aqueous coating composition, good resistance is achieved on the part of the resulting topcoat toward UV radiation, especially with respect to UV-A radiation.

It has been surprisingly found, moreover, that by virtue of the specific constituents of the coating composition used in accordance with the invention, in particular the presence of the at least one mixed hydroxide of the general formula (I) in the aqueous coating composition, it is possible, using the coil coating process, to obtain topcoats which are distinguished not only by good adhesion properties to the underlying coat such as a primer coat, but also, moreover, by good gloss. Surprisingly it has been possible to observe such a good gloss or a high gloss retention, in particular a gloss retention of at least 80%, even after sustained irradiation of the topcoat with UV-A radiation over an uninterrupted time of 12 weeks.

The term “comprising” in the sense of the present invention, in connection for example with the aqueous coating composition used in accordance with the invention in step (a), has in one preferred embodiment the meaning of “consisting of”. In this case, with regard to the aqueous coating composition used in accordance with the invention, in this preferred embodiment, besides the components (A), water, and the mixed hydroxide of the general formula (I), there may optionally also be (B) and/or (C) and/or (D) included in the coating composition used in accordance with the invention. All of the components, in each case in one of their preferred embodiments as specified below, may be present in the coating composition used in accordance with the invention. The same also applies for the process of the invention and for the steps involved mandatorily and optionally in that process, and to preferred embodiments of these steps: here as well, the term “comprising” in the sense of the present invention has in one preferred embodiment the meaning of “consisting of”.

### Coil Coating Process

Application of a topcoat to at least one side of a substrate is possible by means of the process of the invention. Also possible in principle is similar double-sided coating of the substrate, but preferably a topcoat is applied to one side of the substrate.

In step (a) of the process of the invention, an at least partial, preferably complete, coating on at least one, preferably precisely one, substrate metal surface coated at least partly, preferably completely, with at least one, preferably precisely one, primer coat is coated with an aqueous coating composition used in accordance with the invention, to give a topcoat. Where only partial coating takes place, this partial coating takes place preferably on at least part of the substrate metal surface coated with at least one primer coat.

The process of the invention is preferably a continuous process.

The topcoat in step (a) of the process of the invention is applied preferably with a dry film thickness of up to 30 μm, more particularly up to 25 μm, such as a dry film thickness in the range from 10 to 27 μm or 10 to 25 μm, for example, to a substrate metal surface coated at least partly with at least one primer coat as per step (3) set out below, by means of the aqueous coating composition used in accordance with the invention. The coating composition used in accordance with the invention is applied preferably as topcoat in a dry film thickness in the range from 10 to 25 μm or from 10 to <28 μm or from 10 to <27 μm, more particularly from 10 to 25 μm. With particular preference the coating composition of the invention is applied as a topcoat in a dry film thickness in the range from 10 to 25 μm or from 10 to 20 μm, very preferably in the range from 12 to 25 μm, more particularly in the range from 15 to 25 μm. The dry film thickness is determined by the method described below. This coat is typically applied in a roll application process.

The substrate used can be any article which has at least one metallic surface, more particularly a metal strip.

The term “metal strip” in the sense of the present invention refers preferably not only to strips consisting entirely of at least one metal but also to strips which are only coated with at least one metal, i.e., have at least one metallic surface, and themselves consist of different kinds of material, such as of polymers or composite materials. “Strips” in the sense of the present invention are preferably sheetlike elements having at least one metallic surface, more preferably selected from the group consisting of sheets, foils, and plates. The term “metal” preferably also encompasses alloys. In one preferred embodiment a “metal strip” in the sense of the present invention consists entirely of metals and/or alloys. The metals or alloys in question are preferably non-noble metals or alloys which are typically employed as metallic materials of construction and which require protection against corrosion.

All customary metal strips known to the skilled person may be coated by means of the process of the invention. The metals used for producing the metal strips of the invention are preferably selected from the group consisting of iron, steel, zinc, zinc alloys, aluminum, and aluminum alloys. The metal may optionally have been galvanized, such as galvanized iron or galvanized steel, for example, such as electrolytically galvanized or hot-dip-galvanized steel. Zinc alloys or aluminum alloys and also their use for the coating of steel are known to the skilled person. The skilled person selects the nature and amount of alloying constituents in accordance with the desired end use. Typical constituents of zinc alloys include more particularly Al, Pb, Si, Mg, Sn, Cu, or Cd. Typical constituents of aluminum alloys include more particularly Mg, Mn, Si, Zn, Cr, Zr, Cu, or Ti. The term “zinc alloy” is also intended to include Al/Zn alloys in which Al and Zn are present in approximately equal amounts, and also Zn/Mg alloys in which Mg is present in an amount of 0.1 to 10 wt %, based on the total weight of the alloy. Steel coated with alloys of these kinds is available commercially. The steel itself may include the customary alloying components known to the skilled person.

In the coil coating process of the invention, metal strips with a thickness of preferably 0.2 to 2 mm and a width of up to 2 m are transported at a speed of up to 200 m/min through a coil coating line, in the course of which they are coated.

Typical apparatus in which the process of the invention can be implemented comprises a feed station, a strip store, a cleaning and pretreatment zone, in which the optional cleaning may take place and an optional pretreatment coat may be applied, a first coating station for applying the primer coat, along with drying oven and downstream cooling zone, a second coating station for applying the topcoat, with drying oven, laminating station, and cooling, and a strip store and a winder (2-coat line). In the case of a 1-coat line, in contrast, optional cleaning and also the application of a pretreatment primer coat take place in a combined cleaning, pretreatment, and coating zone together with drying oven and downstream cooling zone. This is followed by a coating station for applying a topcoat, with drying oven, laminating station, and cooling, and by a strip store and a winder.

The process of the invention preferably comprises, before step (a) is carried out, the following step or steps, preferably in the order indicated below:
(1) optionally cleaning the substrate metal surface to remove soiling,
(2) optionally at least partly applying at least one pretreatment coat to the optionally cleaned substrate metal surface,
(3) at least partly applying at least one primer coat to the metal surface optionally subjected to treatment as per steps (1) and/or (2), and optionally curing the thus-applied primer coat or curing the pretreatment coat and the primer coat.

For cleaning in the optional step (1) of the invention preferably comprises the degreasing of the metal surface of the substrates such as, for example, of the metal strip. In the course of this cleaning it is possible to remove soiling which has accumulated during storage, or to remove temporary corrosion control oils by means of cleaning baths.

The pretreatment coat in the optional step (2) of the process of the invention is applied preferably in a dry film thickness in a range from 1 to 10 μm, more preferably in a range from 1 to 5 μm. Alternatively the pretreatment coat may also have a dry film thickness<1 μm, as for example in the range from <1 μm to 5 μm. Application of the pretreatment coat takes place preferably in a dipping or spraying process or by roll application. This coat is intended to increase the corrosion resistance and may also serve to improve the adhesion of subsequent coats to the metal surface. Known pretreatment baths include, for example, those containing Cr(VI), those containing Cr(III), and also chromium-free baths, such as, for example, those containing phosphate.

Step (2) may alternatively also take place with an aqueous pretreatment composition which comprises at least one water-soluble compound containing at least one Ti atom and/or at least one Zr atom, and comprising at least one water-soluble compound as a source of fluoride ions, containing at least one fluorine atom, or with an aqueous pretreatment composition which comprises a water-soluble compound obtainable by reaction of at least one water-soluble compound containing at least one Ti atom and/or at least one Zr atom, and comprising at least one water-soluble compound as a source of fluoride ions, containing at least one fluorine atom, or with an aqueous pretreatment composition which comprises a water-soluble compound obtainable by reaction of at least one water-soluble compound containing at least one Ti atom and/or at least one Zr atom with at least one water-soluble compound as a source of fluoride ions, containing at least one fluorine atom. The at least one Ti atom and/or the at least one Zr atom here preferably has/have the +4 oxidation state. By virtue of the components present in the aqueous pretreatment composition, and preferably also by virtue of the appropriately selected proportions thereof, the composition preferably comprises a fluoro complex such as, for example, a hexafluorometallate, i.e., more particularly hexafluorotitanate and/or at least one hexafluorozirconate. The overall concentration of the elements Ti and/or Zr in the pretreatment composition preferably is not below 2.5·10⁻⁴ mol/L but is not greater than 2.0·10⁻² mol/L. The preparation of such pretreatment compositions and their use in pretreatment is known from WO 2009/115504 A1, for example. The pretreatment composition preferably further comprises copper ions, preferably copper(II) ions, and also, optionally, one or more water-soluble and/or water-dispersible compounds comprising at least one metal ion selected from the group consisting of Ca, Mg, Al, B, Zn, Mn and W, and also mixtures thereof, preferably at least one aluminosilicate and in that case more particularly one which has an atomic ratio of Al to Si atoms of at least 1:3. The preparation of such pretreatment compositions and their use in pretreatment is likewise known from WO 2009/115504 A1. The aluminosilicates are present preferably in the form of nanoparticles, having an average particle size which is determinable by dynamic light scattering in the range from 1 to 100 nm. The average particle size of such nanoparticles which is determinable by dynamic light scattering, in the range from 1 to 100 nm, is determined here in accordance with DIN ISO 13321 (date: Oct. 1, 2004). The metal surface after step (2) preferably has a pretreatment coat. Alternatively step (2) may also take place with an aqueous sol-gel composition.

The primer coat, i.e., a layer of primer, is applied preferably in step (3) of the process of the invention with a dry film thickness in a range from 5 to 45 μm, more preferably in a range from 2 to 35 μm, more particularly in a range from 2 to 25 μm. This coat is typically applied in a roll application process. Primer coats of this kind are known from WO 2006/079628 A1, for example.

After step (a) has been carried out, the process of the invention preferably further comprises step (b) of
(b) curing the applied topcoat.

The curing in step (b) takes place preferably at temperatures above room temperature, i.e., above 18-23° C., more preferably at temperatures≥80° C., even more preferably ≥110° C., very preferably ≥140° C., and especially preferably ≥170° C. Particularly advantageous is curing at 100 to 350° C., more preferably at 150 to 350° C., and very preferably at 200 to 300° C. Curing takes place preferably over a time of 10 s to 240 s, more preferably of 20 s to 180 s, very preferably 25 s to 150 s.

Step (b) takes place preferably at a substrate temperature in the range from ≥170° C. to 350° C. over a time of 20 s to 180 s.

### Aqueous Coating Composition Used in Step (a)

The fractions in wt % of all of the components present in the coating composition used in accordance with the invention, such as (A), water, and the mixed hydroxide of the general formula (I), and also, optionally, (B) and/or (C) and/or (D), add up preferably to 100 wt %, based on the total weight of the coating composition.

The coating composition used in accordance with the invention in step (a) comprises water as liquid diluent, i.e., is aqueous.

The term “aqueous” in connection with the coating composition used in accordance with the invention refers preferably to those coating compositions which as liquid diluent—i.e., as liquid solvent and/or dispersion medium—comprise water as the main component and are therefore at least substantially free of organic solvents. Optionally, however, the coating compositions used in accordance with the invention may include at least one organic solvent in small fractions. Examples of such organic solvents include heterocyclic, aliphatic, or aromatic hydrocarbons, mono- or polyfunctional alcohols, ethers, esters, ketones, and amides, such as N-methylpyrrolidone, N-ethylpyrrolidone, dimethylformamide, toluene, xylene, butanol, ethyl glycol and butyl glycol, and also their acetates, butyl diglycol, diethylene glycol dimethyl ether, cyclohexanone, methyl ethyl ketone (MEK), methyl isobutyl ketone (MIBK), acetone, isophorone, or mixtures thereof, for example, more particularly methyl ethyl ketone (MEK) and/or methyl isobutyl ketone (MIBK). The fraction of these organic solvents is preferably not more than 20.0 wt %, more preferably not more than 15.0 wt %, very preferably not more than 10.0 wt %, more particularly not more than 5.0 wt % or not more than 4.0 wt % or not more than 3.0 wt %, even more preferably not more than 2.5 wt % or not more than 2.0 wt % or not more than 1.5 wt %, most preferably not more than 1.0 wt % or not more than 0.5 wt %, based in each case on the total fraction of the liquid diluents, i.e., liquid solvents and/or dispersion media, that are present in the coating composition used in accordance with the invention. More particularly, however, there are no organic solvents in the coating composition used in accordance with the invention—that is, the coating composition used in accordance with the invention comprises water as sole diluent.

The coating composition used in accordance with the invention in step (a) preferably has a nonvolatile fraction in the range from 5 to 80 wt % or in the range from 10 to 60 wt %, more preferably in the range from 15 to 55 wt %, very preferably in the range from 20 to 50 wt %, based on the total weight of the coating composition. The nonvolatile fraction is determined in accordance with the method described below.

The aqueous coating composition used in accordance with the invention is produced using customary processes, in particular by simple mixing of the respective components used in its production, by means, for example, of high-speed stirrers, stirred tanks, agitator mills, dissolvers, kneading devices, or inline dissolvers.

### Mixed Hydroxide of the General Formula (I)

The aqueous coating composition used in step (a) of the process of the invention comprises at least one mixed hydroxide of the general formula (I) below:

{[(M²⁺₍₁₋ₓ₎)(M³⁺₍ₓ₎)(OH)₂][A^{y-}_{(x/y)}]}·(H₂O)ₙ (I),

wherein
M²⁺ stands for divalent metallic cations,
M³⁺ stands for trivalent metallic cations,
A^{y-} stands for anions of average valence y,
x stands for a value in the range from 0.05 to 0.50, and
n stands for a value in the range from 0 to 10.

The mixed hydroxides of the general formula (I) that are used in accordance with the invention are known to the skilled person by the term, for example, “layered double hydroxides” (LDH). The mixed hydroxides of the general formula (I) that are used in accordance with the invention occur naturally, but may also be produced synthetically or semisynthetically. The mixed hydroxides of the general formula (I) that are used in accordance with the invention customarily have a layerlike structure similar to that of brucite (Mg(OH)₂), with a negatively charged layer of intercalated anions being present in each case between two positively charged metal hydroxide layers (formed, for example, by respective divalent cations M²⁺ and by respective trivalent cations M³⁺), it being possible for this anion layer to contain water additionally, such as water of crystallization. The structure is therefore typically one of alternating positively and negatively charged layers, forming a layer structure by means of corresponding ionic interactions. The divalent and trivalent metallic cations and also hydroxide ions are preferably situated in a regular arrangement of edge-linked octahedra in the positively charged metal hydroxide layers, and the intercalated anions A^{y-} in the respective negatively charged interlayers, it being possible for water to be present additionally such as water of crystallization. Mixed hydroxides of the general formula (I) that are used in accordance with the invention are known to the skilled person from WO 2009/062621 A1, WO 2010/130308 A1, and WO 2013/056846 A1, for example, and also from WO 2010/066642 A1.

The average valence in connection with the anions A^{y-} for the purpose of the present invention should be understood preferably as the average value of the valences of the optionally different anions A^{y-} present. As evident to the skilled person, different anions which differ in their valence, such as CO₃²⁻ as an example of a divalent anion with y=2, and HSO₄⁻ as an example of a monovalent anion with y=1, for example, may each contribute, according to their respective fraction among the total amount of anions A^{y-} (weighting factor), to an individual average valence. Both organic and inorganic anions are contemplated. Preferably, the mixed hydroxide of the general formula (I) that is used in accordance with the invention contains only one kind of anions A^{y-}, preferably carbonate anions (CO₃²⁻).

The average valence y of the anions A^{y-} is preferably in the range from 1 to 3, more preferably in the range from 1 to 2.

The anions A^{y-} are preferably selected from the group consisting of CO₃²⁻, HCO₃⁻, F⁻, Cl⁻, Br⁻, BO₃³⁻, PO₄³⁻, H₂PO₄⁻, HPO₄²⁻, SO₄²⁻, HSO₄⁻, SO₃²⁻, HSO₃⁻, NO₃⁻, and OH⁻. Particularly preferably the anions A^{y-} are selected from the group consisting of CO₃²⁻, Cl⁻, Br⁻, BO₃³⁻, PO₄³⁻, SO₄²⁻, HSO₄⁻, SO₃²⁻, NO₃⁻, and OH⁻. Very preferably the anions A^{y-} are selected from the group consisting of CO₃²⁻ and mixtures of CO₃²⁻ with at least one further anion selected from the group consisting of HCO₃⁻, F⁻, Cl⁻, Br⁻, BO₃³⁻, PO₄³⁻, H₂PO₄⁻, HPO₄²⁻, SO₄²⁻, HSO₄⁻, SO₃²⁻, HSO₃⁻, NO₃⁻, and OH⁻, or with at least one further anion selected from the group consisting of Cl⁻, Br⁻, BO₃³⁻, PO₄³⁻, SO₄²⁻, HSO₄⁻, SO₃²⁻, NO₃⁻, and OH⁻.

The parameter x stands preferably for a value in the range from 0.15 to 0.40, more preferably for a value in the range from 0.25 to 0.35.

The divalent metallic cations M²⁺ are preferably selected from the group consisting of Zn²⁺, Mg²⁺, Ca²⁺, Ba²⁺, Cu²⁺, Ni²⁺, Co²⁺, Fe²⁺, Mn²⁺, Cd²⁺, Sn^{2+,} Pb²⁺, and Sr²⁺, and also mixtures thereof, more preferably selected from the group consisting of Zn²⁺, Mg²⁺, Ca²⁺, Ba²⁺, Cu²⁺, Co²⁺, Fe²⁺, and Mn²⁺, and also mixtures thereof, and more particularly selected from the group consisting of Zn²⁺ and/or Mg²⁺.

The trivalent metallic cations M³⁺ are preferably selected from the group consisting of Al³⁺, Bi³⁺, Fe³⁺, Ce³⁺, Cr³⁺, Ga³⁺, Ni³⁺, Co³⁺, Mn³⁺, V³⁺, Ce³⁺, and La³⁺, and also mixtures thereof, more preferably selected from the group consisting of Al³⁺, Bi³⁺, Fe³⁺, Co³⁺, Mn³⁺, Ce³⁺, and La³⁺, and also mixtures thereof, and more particularly are Al³⁺.

The divalent metallic cations M²⁺ are preferably selected from the group consisting of Zn²⁺, Mg²⁺, Ca²⁺, Ba²⁺, Cu²⁺, Ni²⁺, Co²⁺, Fe²⁺, Mn²⁺, Cd²⁺, Sn²⁺, Pb²⁺, and Sr²⁺, and also mixtures thereof, more preferably selected from the group consisting of Zn²⁺, Mg²⁺, Ca²⁺, Ba²⁺, Cu²⁺, Co²⁺, Fe²⁺, and Mn²⁺, and also mixtures thereof, and more particularly selected from the group consisting of Zn²⁺ and/or Mg²⁺, and

the trivalent metallic cations M³⁺ are preferably selected from the group consisting of Al³⁺, Bi³⁺, Fe³⁺, Ce³⁺, Cr³⁺, Ga³⁺, Ni³⁺, Co³⁺, Mn³⁺, V³⁺, and La³⁺, and also mixtures thereof, more preferably selected from the group consisting of Al³⁺, Bi³⁺, Fe³⁺, Co³⁺, Mn³⁺, Ce³⁺, and La³⁺, and also mixtures thereof, and more particularly are Al³⁺.

The mixed hydroxides of the general formula (I) that are used in accordance with the invention are preferably what are called hydrotalcites: in the hydrotalcites, preferably, Mg²⁺ is present as at least one divalent cation, Al³⁺ is present as at least one trivalent cation, and CO₃²⁻ is present as at least one anion A^{y-}.

The preparation of the mixed hydroxides of the general formula (I) from mixtures of inorganic salts of the metallic cations may in principle take place in aqueous phase at basic pH levels which are defined and are kept constant, with compliance with the required and/or desired proportions (stoichiometries) of divalent and trivalent metallic cations. Where the synthesis takes place in the presence of carbon dioxide, as for example under atmospheric conditions and/or through addition of carbonates, the mixed hydroxides of the general formula (I) generally comprise carbonate as intercalated anion. The reason for this is that the carbonate has a high affinity for intercalation into the layer structure of the mixed hydroxides of the general formula (I). This method is employed with particular preference for preparing the mixed hydroxides of the general formula (I).

Where operation takes place with at least partial exclusion of carbon dioxide and carbonates (for example, nitrogen or argon inert gas atmosphere, salts not carbonate-containing), the mixed hydroxides of the general formula (I) generally comprise at least in part the inorganic anions of the metal salts used, chloride ions for example, as intercalated anions. The synthesis may also be carried out entirely to the exclusion of carbon dioxide (inert gas atmosphere) and/or carbonate, and in the presence, for example, of organic anions or their acidic precursors which are not present as anion in the metal salts. In that case, generally speaking, the resulting mixed hydroxide of the general formula (I) has intercalated the corresponding organic anions. As a result of the abovementioned method, therefore, referred to as the direct coprecipitation method (or template method), the desired mixed hydroxides of the general formula (I) are obtained in a one-step synthesis.

An alternative synthesis route for the preparation of the mixed hydroxides lies in the hydrolysis of metal alkoxides in the presence of the desired anions to be intercalated (U.S. Pat. No. 6,514,473). Moreover, the mixed hydroxides of the general formula (I) may be prepared using what is called the anionic exchange reaction method. In this case the capacity of the mixed hydroxides of the general formula (I) to be able to exchange intercalated anions is exploited. The layer structure of the cationic mixed metal hydroxide layers of the mixed hydroxides of the general formula (I) is retained. First of all, ready-prepared mixed hydroxides of the general formula (I) are suspended in aqueous alkaline solution under an inert gas atmosphere, for example. This suspension or slurry is then added to an aqueous alkaline solution of the further anions to be intercalated, under an inert gas atmosphere, for example, and the combined system is stirred for a certain time, as for example 1 hour to 10 days, more particularly 1 to 5 days. The mixed hydroxides of the general formula (I) are then obtained again in the form of a slurry after centrifuging and repeated washing with water.

The at least one mixed hydroxide of the general formula (I) preferably has an average particle diameter in the range from 0.1 to 10 μm, more preferably in the range from 0.1 to 7.5 μm, very preferably in the range from 0.1 to 5 μm, more particularly in the range from 0.1 to <1 μm. The average particle diameter is determined by the method indicated below.

The at least one mixed hydroxide of the general formula (I) is included in the aqueous coating composition used in accordance with the invention preferably in an amount in a range from 0.5 to 25.0 wt %, more preferably in a range from 0.75 to 20.0 wt %, very preferably in a range from 1.0 to 15.0 wt %, more particularly in a range from 1.5 to 10 wt %, most preferably in a range from 2.0 to 8 wt %, based in each case on the total weight of the coating composition.

Mixed hydroxides of the general formula (I) that are used in accordance with the invention are available commercially, from Kisuma Chemicals, Japan, for example.

### Polymer (A)

The coating composition used in accordance with the invention in step (a) comprises at least one polymer (A) soluble or dispersible therein. The polymer (A) represents a polymeric resin. In combination with the crosslinking agent (B) that is optionally likewise present, the polymer (A) constitutes at least part of the binder present in the coating composition. The term “binder” is understood in the sense of the present invention, in agreement with DIN EN ISO 4618 (German version, date: March 2007), as being preferably the nonvolatile fractions of a coating composition, such as of the coating composition used in accordance with the invention, that are preferably responsible for film formation. Pigments and/or fillers present in the composition, such as the optional component (C), are therefore not subsumed by the term “binder”. The nonvolatile fraction may be determined by the method described below.

The polymer (A) preferably has reactive functional groups which allow a crosslinking reaction. Any customary crosslinkable reactive functional group known to the skilled person is suitable here as a crosslinkable reactive functional group. The polymer (A) preferably has reactive crosslinkable functional groups selected from the group consisting of primary amino groups, secondary amino groups, hydroxyl groups, thiol groups, carboxyl groups, epoxide groups, and groups which have at least one C═C double bond, such as, for example, groups which have at least one ethylenically unsaturated double bond, such as vinyl groups and/or (meth)acrylate groups. More particularly the polymer (A) used in accordance with the invention has crosslinkable hydroxyl groups and/or crosslinkable carboxyl groups, most preferably crosslinkable hydroxyl groups. This polymer (A) may be self-crosslinking or externally crosslinking, preferably externally crosslinking. In order to enable an external crosslinking reaction, the coating composition of the invention preferably comprises at least one crosslinking agent (B) as well as the polymer (A). The polymer (A) preferably has a fraction of crosslinkable reactive functional groups, more particularly hydroxyl groups, in the range from 0.25 wt % to 4.5 wt %, more preferably from 0.5 to 4.0 wt %, very preferably from 0.75 to 3.5 wt %, more particularly from 1.0 to 3.0 wt %, based in each case on the total weight of the solids fraction of the polymer (A).

The polymer (A) present in the aqueous coating composition used in accordance with the invention is preferably thermally crosslinkable. The polymer (A) is preferably crosslinkable on heating to a substrate temperature above room temperature, i.e., at a substrate temperature of 18-23° C. Preferably the binder (A) is crosslinkable only at substrate temperatures≥80° C., more preferably ≥110° C., very preferably ≥130° C., and especially preferably ≥140° C. With particular advantage the polymer (A) is crosslinkable at a substrate temperature in the range from 100 to 350° C., more preferably at 125 to 350° C., very preferably at 150 to 275° C., especially preferably at 175 to 275° C., with more particular preference at 200 to 275° C., and most preferably at 225 to 275° C.

As polymer (A) use may preferably be made of at least one polymer selected from the group consisting of polyurethanes, polyesters, polyamides, polyureas, polystyrenes, polycarbonates, poly(meth)acrylates, epoxy resins, phenol-formaldehyde resins, phenolic resins, and silicone resins, and also mixtures thereof, with preferably 70 to 100 wt % of the polymers (A) present in the coating composition being selected from at least one of the aforementioned polymers. Among the stated polymers, the reference in each case is preferably both to homopolymers and to copolymers.

The polymer (A) preferably has a weight-average molecular weight of 2000 to 200 000 g/mol, more preferably of 5000 to 150 000 g/mol, very preferably of 6000 to 100 000 g/mol, more particularly of 7000 to 80 000 g/mol or of 10 000 to 60 000 g/mol or of 12 000 to 40 000 g/mol or of 12 000 to 30 000 g/mol. The method for determining the weight-average molecular weight is described below.

The polymer (A) preferably has a number-average molecular weight of 100 to 10 000 g/mol, more preferably of 200 to 5000 g/mol, very preferably of 250 to 2500 g/mol, more particularly of 300 to 1000 g/mol. The method for determining the number-average molecular weight is described below.

The binder (A) preferably has an acid number in the range from 2 to 50, more preferably from 3 to 45, very preferably from 4 to 40, especially preferably from 5 to 35 or from 5 to 30 or from 5 to 20 mg KOH per g binder (A). The method for determining the acid number is described below.

Preference is given to using as polymer (A) at least one polymer which has OH groups and is based on at least one polyurethane and/or at least one polyester.

The preparation of polyurethane-based polymers such as polyurethanes by a polyaddition reaction of at least one isocyanate, such as a diisocyanate, for example, with at least one polyol, such as a diol, for example, is familiar to the skilled person. Preferred polyol components used for preparing polyurethane-based polymers (A) are polyester polyols, polycarbonate polyols, polydimethylsiloxane polyols and/or polyether polyols. Polyester polyols are particularly preferred.

As polyisocyanates such as diisocyanates, for example, it is possible to use the same components that can also be used as crosslinking agents (B).

Preferably, therefore, the polymer (A) used in accordance with the invention is a polyester-polyurethane resin. The polymer (A) is accordingly prepared preferably using a polyester polyol as prepolymer polyol component. Particularly suitable polyester polyols are compounds which derive from at least one polyol such as at least one diol, as for example ethylene glycol, propylene glycol (1,2-propanediol), trimethylene glycol (1,3-propanediol), neopentyl glycol, 1,4-butanediol and/or 1,6-hexanediol, or such as at least one triol such as 1,1,1-trimethylolpropane (TMP), and from at least one dicarboxylic acid such as, for example, adipic acid, terephthalic acid, isophthalic acid, ortho-phthalic acid and/or dimethylolpropionic acid, and/or from at least one dicarboxylic acid derivative such as dicarboxylic ester and/or a dicarboxylic anhydride such as phthalic anhydride. Especially preferred is a polyester polyol of this kind, used as prepolymer polyol component, that derives from at least one diol and/or triol selected from the group consisting of 1,6-hexanediol, neopentyl glycol, trimethylolpropane, and mixtures thereof, and from at least one dicarboxylic acid (or at least one dicarboxylic acid derivative thereof) selected from the group consisting of adipic acid, terephthalic acid, isophthalic acid, ortho-phthalic acid, dimethylolpropionic acid, and mixtures thereof. Preferably at least one such polyester polyol is used with at least one polyisocyanate, more particularly with HDI such as trimerized HDI, for preparing the polyurethane resin on which the polymer (A) is based.

In order to permit dissolution or dispersion of a polyurethane resin of this kind, ionic and/or hydrophilic segments are commonly incorporated into the polyurethane chain in order to stabilize the dispersion. Soft segments used may be preferably 20 to 100 mol % of diols of higher or lower molecular mass, such as dimethylolpropionic acid, for example, based on the amount of all the polyols, preferably polyester polyols, having a number-average molecular weight M of 500 to 5000 g/mol, preferably of 1000 to 3000 g/mol. In this case, first of all, a prepolymer is prepared from at least one polyol such as at least one polyester polyol and from at least one polyisocyanate such as at least one diisocyanate, more particularly HDI, and has isocyanate groups as terminal reactive groups, owing to an excess of polyisocyanate used. In the second step, these propolymers are joined to one another to form long-chain molecules, using higher or lower molecular mass diols as chain extenders, such as dimethylolpropionic acid, for example, optionally in the presence of water. By way of chain extenders of this kind it is possible to incorporate ionic groups into the polymer, in order to stabilize it in the form of particles in dispersion in water. Where, for example, dimethylolpropionic acid is used as chain extender, it is possible to incorporate a carboxyl functionality into the polymer, which can be deprotonated, thereby permitting the generation of anionic segments within the polymer. Alternatively, first of all, a component used as chain extender, such as dimethylolpropionic acid, may be reacted with at least one polyisocyanate such as at least one diisocyanate, more particularly HDI such as trimerized HDI, to give—as a result of an excess of polyisocyanate used—a reaction product which has isocyanate groups as terminal reactive groups. These isocyanate groups in the resultant reaction product can then be reacted subsequently with at least one aforementioned prepolymer of at least one polyol such as at least one polyester polyol, to give a corresponding polyurethane.

Suitable polyurethanes such as Bayhydrol® U 2841 XP from Bayer, for example, which can be used as polymers (A) are available commercially.

The coating composition used in accordance with the invention may optionally comprise two polymers (A) different from one another. Where, for example, at least one polymer is used as polymer (A) that has OH groups and is based on at least one polyurethane and/or at least one polyester, the coating composition used in accordance with the invention may further comprise another polymer (A) different from the first. This other polymer (A) is preferably at least one copolymer obtainable by copolymerization of ethylenically unsaturated monomers in the presence of at least one polyurethane resin having polymerizable carbon double bonds. Copolymers of this kind which can be used as other polymer (A) are known from WO 91/15528 A1, for example, and can therefore be easily prepared by the skilled person.

### Crosslinking Agent (B) Present Optionally

The crosslinking agent (B) present optionally in the coating composition used in accordance with the invention in step (a) is different from the component (A).

The coating composition preferably comprises at least one crosslinking agent (B).

The crosslinking agent (B) is suitable preferably for thermal crosslinking and/or curing. Such crosslinking agents are known to the skilled person. To accelerate the crosslinking, suitable catalysts may be added to the aqueous coating composition.

All customary crosslinking agents (B) known to the skilled person may be used. Examples of suitable crosslinking agents are melamine resins, amino resins, resins or compounds containing anhydride groups, resins or compounds containing epoxide groups, tris(alkoxy-carbonylamino)triazines, resins or compounds containing carbonate groups, blocked and/or nonblocked polyisocyanates, β-hydroxyalkylamides, and also compounds having on average at least two groups capable of transesterification, examples being reaction products of malonic diesters with polyisocyanates or of esters and part-esters of polyhydric alcohols and malonic acid with monoisocyanates. Where blocked polyisocyanates are selected as crosslinking agents, the aqueous coating composition used in accordance with the invention is formulated as a 1-component (1-K) composition. Where nonblocked polyisocyanates are selected as crosslinking agents, the aqueous coating composition is formulated as a 2-component (2-K) composition.

One particularly preferred crosslinking agent (B) is selected from the group consisting of blocked and nonblocked polyisocyanates and melamine resins such as melamine-formaldehyde condensation products, more particularly etherified (alkylated) melamine-formaldehyde condensation products, and also mixtures thereof.

Blocked polyisocyanates which can be utilized are any desired polyisocyanates such as, for example, diisocyanates in which the isocyanate groups have been reacted with a compound so that the blocked polyisocyanate formed is stable in particular toward reactive functional groups such as hydroxyl groups, for example, at room temperature, i.e., at a temperature of 18 to 23° C., but reacts at elevated temperatures, as for example at ≥80° C., more preferably ≥110° C., very preferably ≥130° C., and especially preferably ≥140° C., or at 90° C. to 300° C. or at 100 to 250° C., more preferably at 125 to 250° C., and very preferably at 150 to 250° C. In the preparation of the blocked polyisocyanates it is possible to use any organic polyisocyanates suitable for crosslinking. As polyisocyanates, such as, for example, as diisocyanates, use is made preferably of (hetero)aliphatic, (hetero)cycloaliphatic, (hetero)-aromatic, or (hetero) aliphatic-(hetero) aromatic diiso-cyanates. Preferred diisocyanates are those containing 2 to 36, more particularly 6 to 15 carbon atoms. Preferred examples are ethylene 1,2-diisocyanate, tetramethylene 1,4-diisocyanate, hexamethylene 1,6-diisocyanate (HDI), 2,2,4-(2,4,4)-trimethylhexa-methylene 1,6-diisocyanate (TMDI), 1,3-bis(1-isocyanato-1-methylethyl)benzene, diphenylmethane diisocyanate (MDI), 1,9-diisocyanato-5-methylnonane, 1,8-diisocyanato-2,4-dimethyloctane, dodecane 1,12-diisocyanate, ω,ω′-diisocyanatodipropyl ether, cyclobutene 1,3-diisocyanate, cyclohexane 1,3- and 1,4-diisocyanate, 3-isocyanatomethyl-3,5,5-trimethylcyclo-hexyl isocyanate (isophorone diisocyanate, IPDI), 1,4-diisocyanatomethyl-2,3,5,6-tetramethylcyclohexane, de-cahydro-8-methyl(1,4-methanonaphthalen-2(or 3),5-ylene-dimethylene diisocyanate, hexahydro-4,7-methanoindan-1(or 2),5(or 6)-ylenedimethylene diisocyanate, hexahydro-4,7-methanoindan-1(or 2),5(or 6)-ylene diisocyanate, 2,4- and/or 2,6-hexahydrotolylene diisocyanate (H6-TDI), toluene 2,4- and/or 2,6-diisocyanate (TDI), perhydrodiphenylmethane 2,4′-diisocyanate, perhydrodiphenylmethane 4,4′-diisocyanate (H₁₂MDI), 4,4′-diisocyanato-3,3′,5,5′-tetramethyldicyclo-hexylmethane, 4,4′-diisocyanato-2,2′,3,3′,5,5′,6,6′-octamethyldicyclohexylmethane, ω,ω′-diisocyanato-1,4-diethylbenzene, 1,4-diisocyanatomethyl-2,3,5,6-tetra-methylbenzene, 2-methyl-1,5-diisocyanatopentane (MPDI), 2-ethyl-1,4-diisocyanatobutane, 1,10-diisocyanatodecane, 1,5-diisocyanatohexane, 1,3-diisocyanatomethylcyclo-hexane, 1,4-diisocyanatomethylcyclohexane, naphthylene diisocyanate, 2,5(2,6)-bis(isocyanatomethyl)bicyclo-[2.2.1]heptane (NBDI), and also any mixture of these compounds. Polyisocyanates of higher isocyanate functionality may also be used. Examples of such are trimerized hexamethylene diisocyanate and trimerized isophorone diisocyanate. Furthermore, mixtures of polyisocyanates may also be utilized. Especially preferred are toluene 2,4-diisocyanate and/or toluene 2,6-diisocyanate (TDI), or isomer mixtures of toluene 2,4-diisocyanate and toluene 2,6-diisocyanate and/or diphenylmethane diisocyanate (MDI) and/or hexamethylene 1,6-diisocyanate (HDI), preferably each in trimerized form. Especially preferred is trimerized HDI.

Useful likewise as suitable crosslinking agents (B) are melamine resins, preferably melamine-formaldehyde condensation products, more particularly optionally etherified (alkylated, such as C₁-C₆ alkylated for example) melamine-formaldehyde condensation products, which can be dispersed or dissolved in water. Their water-solubility or water-dispersibility is dependent—apart from on the degree of condensation, which is to be as low as possible—on the etherifying component, with only the lowest members of the alkanol or ethylene glycol monoether series producing water-soluble condensates. Particularly preferred are melamine resins etherified with at least one C₁₋₆ alcohol, preferably with at least one C₁₋₄ alcohol, more particularly with methanol (methylated), such as melamine-formaldehyde condensation products. Where solubilizers are used as optional further additives, it is also possible for ethanol-, propanol- and/or butanol-etherified melamine resins, more particularly the corresponding etherified melamine-formaldehyde condensation products, to be dissolved or dispersed in aqueous phase.

In one preferred embodiment the crosslinking agent (B) of the coating composition used in accordance with the invention is at least one melamine resin dispersible or soluble in water, preferably at least one melamine-formaldehyde condensation product dispersible or soluble in water, more particularly at least one etherified (alkylated), preferably methylated melamine-formaldehyde condensation product dispersible or soluble in water.

The aqueous coating composition used in accordance with the invention preferably comprises the crosslinking agent (B) in an amount of 1 to 20 wt %, preferably in an amount of 2 to 15 wt %, more preferably in an amount of 3 to 10 wt %, based on the total weight of the aqueous coating composition.

### Component (C) Present Optionally

The coating composition used in accordance with the invention in step (a) may comprise one or more typically employed components (C).

This component (C) may be at least one pigment and/or filler.

A pigment and/or filler of this kind is preferably selected from the group consisting of organic and inorganic, coloring and extender pigments. Examples of suitable inorganic coloring pigments are white pigments such as zinc white, zinc sulfide, or lithopone; black pigments such as carbon black, iron manganese black, or spinel black; chromatic pigments such as chromium oxide, chromium oxide hydrate green, cobalt green, or ultramarine green, cobalt blue, ultramarine blue, or manganese blue, ultramarine violet or cobalt violet and manganese violet, red iron oxide, cadmium sulfoselenide, molybdate red or ultramarine red; brown iron oxide, mixed brown, spinel phases and corundum phases, or chromium orange; or yellow iron oxide, nickel titanium yellow, chromium titanium yellow, cadmium sulfide, cadmium zinc sulfide, chromium yellow, or bismuth vanadate. Examples of suitable organic coloring pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments, or aniline black. Examples of suitable extender pigments or fillers are chalk, calcium sulfate, barium sulfate, silicates such as talc or kaolin, silicas, oxides such as aluminum hydroxide or magnesium hydroxide, or organic fillers such as textile fibers, cellulose fibers, polyethylene fibers, or polymer powders; for further details, refer to RBmpp Lexikon Lacke und Druckfarben, Georg Thieme Verlag, 1998, pages 250 ff., “Fillers”.

Particularly preferred are titanium dioxide and/or white pigments such as zinc white, zinc sulfide and/or lithopone as at least one pigment and/or filler (C).

Effect pigments, furthermore, may be used as pigments (C) present in the aqueous coating composition used in step (a). A skilled person is familiar with the concept of effect pigments. Effect pigments more particularly are those pigments which impart optical effect or color and optical effect, more particularly optical effect. A corresponding division of the pigments may be made in accordance with DIN 55944 (date: December 2011). The effect pigments are preferably selected from the group consisting of organic and inorganic optical effect and color and optical effect pigments. They are more preferably selected from the group consisting of organic and inorganic optical effect or color and optical effect pigments. The organic and inorganic optical effect and color and optical effect pigments are more particularly selected from the group consisting of optionally coated metallic effect pigments, of optionally coated metal oxide effect pigments, of effect pigments composed of optionally coated metals and nonmetals, and of optionally coated nonmetallic effect pigments. The optionally coated metallic effect pigments, such as silicate-coated metallic effect pigments, for example, are more particularly aluminum effect pigments, iron effect pigments, or copper effect pigments. Especially preferred are optionally coated—such as silicate-coated, for example—aluminum effect pigments, more particularly commercially available products from Eckart such as Stapa® Hydrolac, Stapa® Hydroxal, Stapa® Hydrolux, and Stapa® Hydrolan, most preferably Stapa® Hydrolux and Stapa® Hydrolan. The effect pigments used in accordance with the invention, more particularly optionally coated—such as silicate-coated, for example—aluminum effect pigments, may be present in any customary form known to the skilled person, such as a leaflet form and/or a platelet form, for example, more particularly a (corn)flake form or a silver dollar form. The effect pigments composed of metals and nonmetals are, more particularly, platelet-shaped aluminum pigments coated with iron oxide, of the kind described in, for example, European patent application EP 0 562 329 A2; glass leaflets coated with metals, more particularly aluminum; or interference pigments which comprise a reflector layer made of metal, more particularly aluminum, and which exhibit a strong color flop. The nonmetallic effect pigments are more particularly pearlescent pigments, especially mica pigments; platelet-shaped graphite pigments coated with metal oxides; interference pigments which comprise no metal reflector layer and have a strong color flop; platelet-shaped effect pigments based on iron oxide, having a shade from pink to brownish red; or organic liquid-crystalline effect pigments. For further details of the effect pigments that are used in accordance with the invention, reference is made to RBmpp Lexikon Lacke und Druckfarben, Georg Thieme Verlag, 1998, page 176, “Effect pigments”, and pages 380 and 381, “Metal oxide-mica pigments” to “Metal pigments”.

The amount of pigment and/or filler (C) in the aqueous coating compositions used in accordance with the invention in step (a) may vary. The amount, based on the aqueous coating composition provided in accordance with the invention, is preferably in the range from 0.1 to 50 wt %, more preferably in the range from 1.0 to 45 wt %, very preferably in the range from 2.0 to 40 wt %, especially preferably in the range from 3.0 to 35 wt %, and more particularly in the range from 4.0 to 35 wt %. Alternatively the aqueous coating composition used in accordance with the invention comprises the at least one pigment and/or filler (C) preferably in an amount in a range from 10 to 60 wt %, more preferably from 15 to 55 wt %, very preferably from 20 to 50 wt %, more particularly from 25 to 45 wt %, based in each case on the total weight of the aqueous coating composition.

### Additives (D) Present Optionally

The coating composition used in accordance with the invention in step (a) may comprise one or more typically employed additives as component (D). These additives (D) are preferably selected from the group consisting of antioxidants, antistats, wetting and dispersing agents, emulsifiers, flow control assistants, solubilizers, defoaming agents, wetting agents, stabilizers, preferably heat stabilizers and/or thermal stabilizers, process stabilizers, and UV and/or light stabilizers, UV absorbers, photoprotectants, radical scavengers, deaerators, inhibitors, catalysts, waxes, wetters and dispersants, flexibilizers, flame retardants, reactive diluents, vehicles, hydrophobizing agents, hydrophilizing agents, thixotropic agents, impact tougheners, expandants, process aids, plasticizers, and mixtures of the abovementioned further additives. The amount of additive (D) in the coating composition used in accordance with the invention may vary. The amount, based on the total weight of the coating composition used in accordance with the invention, is preferably 0.01 to 20.0 wt %, more preferably 0.05 to 18.0 wt %, very preferably 0.1 to 16.0 wt %, especially preferably 0.1 to 14.0 wt %, more particularly 0.1 to 12.0 wt %, and most preferably 0.1 to 10.0 wt %, based on the total weight of the coating composition.

The coating composition used in step (a) of the process of the invention preferably comprises no radical scavengers and/or UV absorbers as additional additives.

### Use

A further subject of the present invention is a use of the aqueous coating composition employed in the process of the invention, i.e., of a coating composition which comprises
(A) at least one polymer dissolved or dispersed therein and
(B) optionally at least one crosslinking agent dissolved or dispersed therein
   and further comprises at least one mixed hydroxide of the general formula (I) below

{[(M²⁺₍₁₋ₓ₎)(M³⁺₍ₓ₎)(OH)₂][A^{y-}_{(x/y)}]}·(H₂O)ₙ (I),
wherein
   M²⁺ stands for divalent metallic cations,
   M³⁺ stands for trivalent metallic cations,
   A^{y-} stands for anions of average valence y,
   x stands for a value in the range from 0.05 to 0.50, and
   n stands for a value in the range from 0 to 10,
      for at least partly coating at least one substrate metal surface, coated at least partly with at least one primer coat, with a topcoat in a coil coating process.

All preferred embodiments described hereinabove in connection with the process of the invention, including the aqueous coating composition used in accordance with the invention, are also preferred embodiments in relation to a use of this aqueous coating composition of the invention for at least partly coating at least one substrate metal surface, coated at least partly with at least one primer coat, with a topcoat in a coil coating process.

### Topcoat

A further subject of the present invention is a topcoat which is applied to at least one side of a substrate and which is obtainable by at least partly coating at least one substrate metal surface, coated at least partly with at least one primer coat, by means of the process of the invention.

This topcoat is applied to at least one substrate metal surface coated with at least one primer coat.

### At Least Partly Coated Substrate

A further subject of the present invention is a substrate coated at least partly and on at least one side with a topcoat, obtainable by the process of the invention.

A further subject of the present invention is a component, preferably a metallic component, produced from at least one such coated substrate such as a coated metal strip. Components of this kind may be, for example, bodies and parts thereof for motor vehicles such as automobiles, trucks, motorcycles, and buses, and components of electrical household products or else components from the sector of instrument casings, façade claddings, ceiling sheeting, or window profiles.

### Methods of Determination

### 1. Determination of the Hydroxyl Number

The method for determining the hydroxyl number is based on DIN 53240-2 (date: November 2007). Determination of the hydroxyl number is used to ascertain the amount of hydroxyl groups in a compound. A sample of a compound whose hydroxyl number is to be ascertained is reacted here with acetic anhydride in the presence of 4-dimethylaminopyridine (DMAP) as catalyst, and the hydroxyl groups of the compound are acetylated. For each hydroxyl group there is one molecule of acetic acid formed. The subsequent hydrolysis of the excess acetic anhydride yields two molecules of acetic acid. The consumption of acetic acid is determined by titrimetry from the difference between the main value found and a blank value, which is to be run in parallel.

A sample is weighed out to an accuracy of 0.1 mg, using an analytical balance, into a 150 mL glass beaker, and the sample vessel is subsequently given a magnetic stirring bar and placed into the sample changer of an automatic titrator featuring sample changer and dosing stations for the individual reagents and solvents (Metrohm Titrando 835 with integrated Karl-Fischer titration stand, from Metrohm). After the sample has been weighed out, the processing sequence is started on the automatic titrator. The following operations are run fully automatically, in the order given below:
Addition of 25 mL of THF and 25 mL of catalyst reagent to all sample vessels
Stirring of the samples for 5-15 minutes, depending on solubility
Addition of 10 mL of acetylation reagent to all sample vessels
13 minutes' waiting, stirring for 15 seconds, further 13 minutes' waiting
Addition of 20 mL of hydrolysis reagent (N,N-dimethylformamide (DMF) and deionized water (DI water) in a ratio of 4:1% by volume) to all sample vessels
7 minutes' waiting, 15 seconds' stirring (3 times in total)
Titration with 0.5 mol/L methanolic KOH

Endpoint recognition takes place potentiometrically. The electrode system used here is an electrode system consisting of a platinum titrode and reference electrode (silver/silver chloride with lithium chloride in ethanol).

The acetylating reagent is prepared by charging 500 mL of DMF to a 1000 mL measuring flask, adding 117 mL of acetic anhydride, and making up to the 1000 mL mark with DMF.

The catalyst reagent is prepared by dissolving 25 g of 4-dimethylaminopyridine (DMAP) in 2.5 L of DMF.

The hydroxyl number (OH number) in mg of KOH/g is calculated according to the following formula:

$$OH number = \frac{( {V}_{2} - {V}_{1} ) \cdot c \cdot 56.1}{m} + A N$$

V1=consumption of KOH in the main test in mL (main value)
V2=consumption of KOH in the blank test in mL (blank value)
c=concentration of potassium hydroxide solution, in mol/L
m=initial mass in g
AN=acid number in mg of KOH/g of sample

### 2. Determination of Number-Average and Weight-Average Molecular Weights

The number-average molecular weight (Mn) is determined by gel permeation chromatography (GPC). This method of determination is based on DIN 55672-1 (date: August 2007). This method can be used to determine not only the number-average molecular weight but also the weight-average molecular weight (Mw) and the polydispersity (ratio of weight-average molecular weight (Mw) to number-average molecular weight (Mn)).

5 mg of a sample (based on the solids fraction) are dissolved using an analytical balance in 1.5 mL of mobile phase. The mobile phase used is tetrahydrofuran containing 1 mol/L of acetic acid. The sample solution is further admixed with 2 μL of ethylbenzene/mL of solution. All insoluble fractions that may be present, such as pigments, for example, are removed by centrifuging or filtration.

The number-average molecular weight (Mn) is determined against polymethyl methacrylate standards of different molecular weights (PMMA standards). Before the beginning of each determination here, a calibration is run. This is done by injecting the PMMA standards (each with a concentration of 0.1 mg/mL in mobile phase (which additionally contains 2 μL of ethylbenzene/mL)). The calibration plot (5th-order polynomial) is constructed from the PMMA standards with different molecular weights, by determining the respective retention time of the individual PMMA standards for the analysis series.

The instrument used is a self-contained system comprising GPC column, Agilent 1100 pump, autosampler and RI detector. The column used is the column set PSS 10e3/10e5/10e6 (300 mm×8 mm; particle size 5 μm).

The following settings are used here:

Injection volume: 100 μL

### Temperature: 35° C.

Flow rate: 1.0 mL/min
Run time: 40 min

Evaluation takes place using PSS analytical software. The concentration of the molecules eluted from the separating columns according to descending coil size is measured using a concentration-sensitive detector, more particularly a differential refractometer. The resulting sample chromatogram is then used, together with the calibration plot determined beforehand for the system, to calculate the relative molar mass distribution, the number-average molecular weight (Mₙ), the weight-average molecular weight (M_{w}), and the polydispersity factor M_{w}/Mₙ. The limits of analysis are specified individually for each sample. The calculated values for Mₙ and M_{w} represent “equivalent PMMA molecular weights”. The absolute molecular weights of the polymers may deviate from these values.

### 3. MEK Test Based on DIN EN 13523-11 (Date: September 2011)

The MEK test serves to determine the resistance of coating films to organic solvents (rub test).

A piece of cotton compress (Art. No. 1225221 from Römer Apotheke Rheinberg) is affixed with a rubber band to the head of an MEK hammer and then soaked with MEK (methyl ethyl ketone) as solvent. The hammer weighs 1200 g and has a handle with a placement area of 2.5 cm². The hammer is likewise filled with solvent, which runs continuously into the cotton compress. This guarantees that the compress is dripping wet throughout the test. A metal test sheet is rubbed once back and forth (=1 DR, one double rub) with the compress, this sheet being like one of the metal test sheets TB1 to TB5 and TV1 to TV4, used in the examples. The test distance here is 9.5 cm. 1 DR here is to be performed in 1 s. During this procedure, no additional force is exerted on the hammer. The top and bottom points of reversal at the edges of the metal test sheet are not evaluated. A count is made of the DRs needed in order to erode the entire coating film on the metal test sheet down to the substrate, and this value is reported. If such erosion is not achieved by the time a maximum of 300 DRs have been reached, the test is terminated after a maximum of 300 DRs.

### 4. Determination of Dry Film Thickness According to DIN EN ISO 2808 (Method 6B) (Date: May 2007)

The coated surface of a substrate coated with at least this coating material, such as one of the metal test sheets TB1 to TB5 or TV1 to TV4, for example, is first marked with a dark or black Edding marker, and then at this marked site it is inscribed at an oblique angle down to the substrate in a V-shape using a cutter (defined by the scratch needle). Using the scale (microscope) built into the PIG film-thickness measuring instrument from Byk Gardner, with a 3419 cutter (1 division=1 μm), the film thickness of the individual coating can be read off. For a film thickness>2 μm, the read-off error is ±10%.

### 5. Determination of the Acid Number

The acid number is determined in accordance with DIN EN ISO 2114 (date: June 2002), using “method B”. The acid number reported corresponds to the total acid number specified in the DIN standard.

### 6. Determination of the Nonvolatile Fraction

The nonvolatile fraction, i.e., the solids content (solids fraction), is determined in accordance with DIN EN ISO 3251 (date: June 2008). The test duration is 60 minutes at a temperature of 130° C.

### 7. Gloss Measurement at 60° Angle According to DIN EN 13523-2 (Date: October 2012)

The gloss measurement at 600 is used to determine the surface gloss of coated areas. Determination takes place using a MICRO TRI-GLOSS gloss meter from BYK. Prior to each measurement, the instrument is calibrated with the installed calibration standards. For the test, the angle setting of 60° is selected on the instrument. 5 measurements are conducted in the longitudinal direction (film-drawing direction or direction of application), by placing the instrument onto the surface in a planar fashion, and reading off the measurement value. From 5 measurement values, an average is calculated and is noted in the test records. Assessment is made by determination of the gloss value (GU) between 0 and 100.

### 8. UVCON Test Procedure According to DIN EN ISO 4892-3 (Date: March 2011)

The test process is an accelerated weathering method for the testing of the light and weather fastness of coating materials, in which 8 fluorescent lamps (UVA 340) simulate the insolation of outdoor weathering. A light/dark cycle and a dry/wet phase simulate the weather conditions.

The specimens are exposed to cycles each of 4 hours of dry UV irradiation at a black panel temperature of (60±3) ° C., followed by 4 hours of water condensation, without irradiation, at a black panel temperature of (40±3) ° C. (one cycle encompasses 8 hours of exposure).

For all of the panels under test, a determination is made of the 60° gloss, as described in Section 7., before the start and after specified cycles. By this means it is possible to determine the percentage drop in gloss after specified cycles. The UVCON test may be conducted over a total duration of 2016 hours, for example.

### 9. Determination of the Average Particle Diameter

The average particle diameter is determined using the Mastersizer 2000 instrument from Malvern Instruments Ltd, UK, by laser diffraction. The determination is carried out in ethanol with an amount of particles whose average diameter is to be determined of 5 wt %, with the resulting dispersions of the samples being treated with ultrasound for 5 minutes prior to measurement for the purpose of complete dispersion of the particles in ethanol. The parameter determined is the average particle diameter (D₅₀ median) based on the sample volume.

The inventive and comparative examples below serve to elucidate the invention, but should not be interpreted as restricting it.

Unless otherwise indicated, the amounts in parts below are parts by weight and the amounts in percent are weight percentages in each case.

### 1. Chemical Characterization of the Raw Materials Used:

Bayhydrol® U 2841 XP is an aqueous dispersion of a polyester-polyurethane functionalized with OH groups, from Bayer AG, having a nonvolatile fraction of 40 to 42 wt %.

Byk® 033 is a defoamer from Byk.

Luwipal® 066 LF is a methylated melamine-formaldehyde resin from BASF SE.

Disperbyk® 190 is a wetting aid dispersing additive from Byk.

Tiona® 696 comprises a titanium dioxide pigment from Cristal (TiO₂ content: 92 wt %).

Omyacarb® extra CL is a calcium carbonate available from Omya Shunda (Linkou) Fine Chemical Co., Ltd., having an average particle diameter of 1.5-13 μm.

Bayhydur® BL XP 2706 is an aqueous dispersion of an aliphatic blocked polyisocyanate from Bayer AG, having a nonvolatile fraction of 38 to 42 wt %.

Cymel® 325 comprises a methylated melamine resin from Allnex, having a nonvolatile fraction of 78 to 82 wt %.

Hydropalat® WE 3370 is a commercially available flow control agent from BASF SE.

Tinstab® BL-277 is dibutyltin dilaurate.

MgAl1 is a hydrotalcite consisting of magnesium aluminum zinc hydroxide carbonate, having an average particle diameter of 0.59 μm.

MgAl2 is a hydrotalcite consisting of magnesium aluminum hydroxide carbonate, having an average particle diameter of 0.45 μm.

### 2. Production of Coating Compositions

The inventively employed coating compositions B1 to B5 and also the comparative coating compositions V1 to V4 as set out in tables 1, 2 and 3 below are produced.

TABLE 1

| Item | Components | V1 | V2 | V3 | B1 | B2 |
|---|---|---|---|---|---|---|
| 1 | Bayhydrol ® U | 26.18 | 26.18 | 26.18 | 26.18 | 26.18 |
| | 2841 XP | | | | | |
| 2 | Disperbyk ® 190 | 7.49 | 7.49 | 7.49 | 7.49 | 7.49 |
| 3 | Byk ® 033 | 0.40 | 0.40 | 0.40 | 0.40 | 0.40 |
| 4 | Tiona ® 696 | 29.94 | 14.97 | 22.45 | 22.45 | 22.45 |
| 5 | Omyacarb ® extra | — | 14.97 | 7.49 | — | — |
| | CL | | | | | |
| 6 | MgAl1 | — | — | — | 6.00 | — |
| 7 | MgAl2 | — | — | — | — | 6.00 |
| 8 | Bayhydrol ® U | 30.00 | 30.00 | 30.00 | 30.00 | 30.00 |
| | 2841 XP | | | | | |
| 9 | Luwipal ® 066 LF | 5.80 | 5.80 | 5.80 | 5.80 | 5.80 |
| 10 | Byk ® 033 | 0.20 | 0.20 | 0.20 | 0.20 | 0.20 |
| Parts by | | 100 | 100 | 100 | 98.5 | 98.5 |
| weight, | | | | | | |
| total | | | | | | |

The respective components as per items 1-7 in table 1 are each mixed in a dissolver and then dispersed in a beadmill to an energy input of 75 Wh/kg. Subsequently, the respective components as per items 8-10 of table 1 are added to each of the resulting mixtures on the dissolver, to give V1 to V3 and B1 and B2, and stirring takes place. Added subsequently to each of the compositions is 1 wt % of Hydropalat® WE 3370, based in each case on the total weight. Added to V2, moreover, are 12 wt %, and to V3 7 wt %, of deionized water, based in each case on the respective total weight.

TABLE 2

| Item | Components | V4 | B3 |
|---|---|---|---|
| 1 | Bayhydrol ® U 2841 XP | 25.82 | 26.21 |
| 2 | Disperbyk ® 190 | 7.38 | 7.49 |
| 3 | Byk ® 033 | 0.39 | 0.40 |
| 4 | Tiona ® 696 | 29.53 | 22.48 |
| 5 | MgAl2 | — | 6.00 |
| 6 | Bayhydrol ® U 2841 XP | 29.59 | 30.03 |
| 7 | Cymel ® 325 | 7.10 | 7.21 |
| 8 | Byk ® 033 | 0.19 | 0.19 |
| Parts by | | 100 | 100 |
| weight, total | | | |

The respective components as per items 1-5 of table 2 are each mixed in a dissolver and then dispersed in a beadmill to an energy input of 75 Wh/kg. The respective components as per items 6-8 of table 2 are added on a dissolver to each of the resulting mixtures to give V4 or B3 and stirring is carried out. Each of the compositions is subsequently admixed with 1 wt % of Hydropalat® WE 3370, based in each case on the total weight.

TABLE 3

| Position | Components | B4 | B5 |
|---|---|---|---|
| 1 | Bayhydrol ® U 2841 XP | 19.16 | 16.59 |
| 2 | Disperbyk ® 190 | 5.48 | 4.74 |
| 3 | Byk ® 033 | 0.29 | 0.25 |
| 4 | Tiona ® 696 | 17.30 | 14.97 |
| 5 | MgAl2 | 4.62 | 4.00 |
| 6 | Bayhydrol ® U 2841 XP | 21.96 | 19.01 |
| 7 | Bayhydur ® BL XP 2706 | 31.04 | 40.31 |
| 8 | Byk ® 033 | 0.14 | 0.13 |
| Parts by | | 100 | 100 |
| weight, total | | | |

The respective components as per items 1-5 of table 3 are each mixed in a dissolver and then dispersed in a beadmill to an energy input of 75 Wh/kg. The respective components as per items 6-8 of table 3 are added on a dissolver to each of the resulting mixtures to give B4 and B5 and stirring is carried out. Each of the compositions is subsequently admixed with 3 wt % of Hydropalat® WE 3370 and also 0.3 wt % of Tinstab® BL-277, based in each case on the total weight.

### 3. Production of Coated Substrates

An OE HDG 5 galvanized steel sheet from Chemetall (thickness 0.81 mm; area: 10.5 cm·30 cm) is first subjected to alkaline cleaning and then cleaned with the commercially available product Gardoclean® S5160 from Chemetall, and is subsequently rinsed with deionized water and then pretreated with the commercially available product Granodine® 1455T from Henkel. Subsequently a primer coat is applied, using a commercially available primer (Coiltec® Universal P CF from BASF Coatings GmbH), to a metal sheet which has been cleaned and pretreated in this way, followed by drying in a tunnel oven for a duration of 49 s at a substrate temperature of 216° C. The primer coat has a dry film thickness of 5 μm. The galvanized steel sheet, cleaned and given a primer coat as above, is referred to hereinafter as sheet T. Subsequently, using a rod coater, one of the coating compositions B1 to B5 or V1 to V4 is applied as a topcoat coating to one thus-coated sheet T, and this is followed by curing under coil coating conditions, specifically at a substrate temperature of 249° C. in a tunnel oven for a time of 63 s. The dry film thickness of the resulting topcoat is 20 μm in each case. The sheets TB1, TB2, TB3, TB4 and TB5, and TV1, TV2, TV3 and TV4, respectively, are obtained.

### 4. Results of Certain Performance Tests

The results of a number of performance tests used to investigate inventive and comparative examples TB1, TB2, TB3, TB4 and TB5, and TV1, TV2, TV3 and TV4, respectively, are set out in table 4 below. Each of the individual parameters is determined in accordance with the method indicated above.

TABLE 4

| | TV1 | TV2 | TV3 | TB1 | TB2 | TV4 | TB3 | TB4 | TB5 |
|---|---|---|---|---|---|---|---|---|---|
| MEK | >300 | >300 | >300 | 20 | 10 | >300 | 220 | >100 | >100 |
| Gloss at 60°, | 65 | 67 | 72 | 39 | 33 | 63 | 48 | 18 | 21 |
| determined | | | | | | | | | |
| before | | | | | | | | | |
| implementation | | | | | | | | | |
| of the UVCON | | | | | | | | | |
| test | | | | | | | | | |
| Gloss at 60°, | 18 | 10 | 13 | 34 | 32 | 37 | 40 | 27 | 24 |
| determined | | | | | | | | | |
| after | | | | | | | | | |
| implementation | | | | | | | | | |
| of the UVCON | | | | | | | | | |
| test over | | | | | | | | | |
| 2016 h | | | | | | | | | |
| Gloss | 28 | 15 | 18 | 87 | 97 | 59 | 83 | 150 | 114 |
| retention | | | | | | | | | |
| after | | | | | | | | | |
| implementation | | | | | | | | | |
| of the UVCON | | | | | | | | | |
| test over | | | | | | | | | |
| 2016 h [%] | | | | | | | | | |

From the results in table 4 it is apparent in particular that use of the inventively employed coating compositions B1 to B5 as topcoat for a substrate T, in comparison to the comparative coating compositions V1 to V4, leads to a significant improvement in the gloss retention (in %) after implementation of the UVCON test over a duration of 2016 h. At the same time, the absolute value of the gloss after implementation of the UVCON test is higher for the inventively employed coating compositions B1 to B5 than for the respective comparative coating compositions V1 to V4, despite the latter formulations having a significantly higher initial gloss. The inventively employed coating compositions B4 and B5 in fact increase their gloss over the course of the test.

1. A process for applying a topcoat to at least one side of a substrate, comprising
(a) at least partly coating at least one substrate metal surface, at least partly coated with at least one primer coat, with an aqueous coating composition,
the aqueous coating composition comprising
(A) at least one polymer dissolved or dispersed therein and
(B) optionally at least one crosslinking agent dissolved or dispersed therein,
wherein the aqueous coating composition further comprises at least one mixed hydroxide of the general formula (I) below
{[(M²⁺₍₁₋ₓ₎)(M³⁺₍ₓ₎)(OH)₂][A^{y-}_{(x/y)}]}·(H₂O)ₙ (I),
in which
M²⁺ stands for divalent metallic cations,
M³⁺ stands for trivalent metallic cations,
A^{y-} stands for anions of average valence y,
x stands for a value in the range from 0.05 to 0.50, and
n stands for a value in the range from 0 to 10, and
wherein the process is a coil coating process.

2. The process as claimed in claim 1, wherein the at least one mixed hydroxide of the general formula (I) has an average particle diameter in the range from 0.1 to 10 μm.

3. The process as claimed in claim 1, wherein the divalent metallic cations M²⁺ are selected from the group consisting of Zn²⁺, Mg²⁺, Ca²⁺, Ba²⁺, Cu²⁺, Ni²⁺, Co²⁺, Fe²⁺, Mn²⁺, Cd²⁺, Sn²⁺, Pb²⁺, and Sr²⁺, and also mixtures thereof, and
the trivalent metallic cations M³⁺ are selected from the group consisting of Al³⁺, Bi³⁺, Fe³⁺, Cr³⁺, Ga³⁺, Ni³⁺, Co³⁺, Mn^{3+,} V³⁺, Ce³⁺, and La³⁺, and also mixtures thereof.

4. The process as claimed in claim 1, wherein the parameter x stands for a value in the range from 0.15 to 0.40.

5. The process as claimed in claim 1, wherein the anions A^{y-} are selected from the group consisting of CO₃²⁻ and mixtures of CO₃²⁻ and at least one further anion selected from the group consisting of Cl⁻, Br⁻, BO₃³⁻, PO₄³⁻, SO₄²⁻, HSO₄⁻, SO₃²⁻, NO₃⁻, and OH⁻.

6. The process as claimed in claim 1, wherein the at least one mixed hydroxide of the general formula (I) is included in the aqueous coating composition in an amount in a range from 1.0 to 15.0 wt %, based on the total weight of the coating composition.

7. The process as claimed in claim 1, wherein the at least one polymer (A) has OH groups and is based on at least one polyurethane and/or at least one polyester.

8. The process as claimed in claim 1, wherein the coating composition comprises at least one crosslinking agent (B) which is selected from the group consisting of optionally alkylated melamine-formaldehyde condensation products, blocked polyisocyanates and nonblocked polyisocyanates, and also mixtures thereof.

9. The process as claimed in claim 1, wherein before (a) the process further comprises
(1) optionally cleaning the substrate metal surface to remove soiling,
(2) optionally at least partly applying at least one pretreatment coat to the optionally cleaned substrate metal surface, and
(3) at least partly applying at least one primer coat to the metal surface optionally subjected to treatment as per (1) and/or (2), and optionally curing the thus-applied primer coat or curing the pretreatment coat and the primer coat.

10. The process as claimed in claim 1, wherein after (a) the process further comprises
(b) curing the applied topcoat.

11. The process as claimed in claim 10, wherein the curing takes place at a substrate temperature in the range from ≥170° C. to 350° C. over a time of 20 s to 180 s.

12. The process as claimed in claim 1, wherein the process is a continuous process.

13. A topcoat applied to at least one side of a substrate, said topcoat being obtained by at least partial coating of at least one substrate metal surface, at least partly coated with at least one primer coat, by means of the process as claimed in claim 1.

14. A substrate coated at least partly and on at least one side with a topcoat, obtained by the process as claimed in claim 1.

15. (canceled)

16. The process according to claim 3 wherein the divalent metallic cations M²⁺ are selected from the group consisting of Zn²⁺ and Mg²⁺.

17. The process according to claim 3 the trivalent metallic cations M³⁺ are Al³⁺.

18. The process according to claim 16 the trivalent metallic cations M³⁺ are Al³⁺.
